(19) United States
(12) Patent Application Publication
(10) Pub. No.: US 2007/0084382 A1
(43) Pub. Date: Apr. 19, 2007

(54) Method for preparing materials containing binder systems derived from amorphous silica and bases

(75) Inventors: Kjeld Holbek, Roskilde (DK); Erik Gydesen Sogaard, Esbjerg (DK)

Correspondence Address: FOLEY AND LARDNER LLP;SUITE 500, 3000 K STREET NW, WASHINGTON, DC, 20007, US

(73) Assignee: AAborg Universitet

(21) Appl. No.: 10/566,784

(22) PCT Filed: Jul. 30, 2004
(86) PCT No.: PCT/DK04/00520

§ 371 Date: Sep. 14, 2006

(30) Foreign Application Priority Data
Aug. 1, 2003 (DK) PA 2003 01118
Jun. 25, 2004 (DK) PA 2004 00997

(51) Int. Cl. C04B 28/26

(52) U.S. Cl. 106/634

(57) ABSTRACT

The present invention concerns a method for preparing materials containing binder systems derived from amorphous silica and bases as well as the materials prepared by the method. Relative to known methods, the present invention allows for continuous production of material as the two components of the binder are brought onto into contact where the binder system is to be applied. The product achieved by the invention has a broad range of applications, such as for construction materials, insulating materials, fire proof materials, reinforcement materials etc. the present invention also relates to a method for preparing materials containing binder systems derived from amorphous inorganic material and bases as well as the materials prepared by the method.

### FIELD OF THE INVENTION

The present invention concerns a method for preparing materials containing binder systems derived from amorphous silica and bases as well as the materials prepared by the method. The present invention also relates to a method for preparing materials containing binder systems derived from amorphous inorganic material and bases as well as the materials prepared by the method.

### BACKGROUND OF THE INVENTION

WO 00/26154 describes binder systems derived from amorphous silica and bases as applied to in particular mineral fibre/particle products.

The disclosure of the above reference is hereby incorporated in the present application by reference and considered part of the present application.

### SUMMARY OF THE INVENTION

Whereas the method by which the materials in disclosed WO 00/26154 are described as being prepared by first preparing the binder from amorphous silica, base and water, and subsequently incorporating the binder onto the aggregate (such as fibres), the present invention provides a different approach.

Thus, in a first aspect the invention concerns a method for preparing a cured product comprising aggregate and a binder system, said binder system being derived from an aqueous mixture of amorphous silica, one or more bases, and optionally additives, said method comprising

1)

a) mixing the aggregate, the one or more bases and optionally additives and water to form a first component (1A);
b) providing amorphous silica, optionally mixed with water, as a second component (1B);
c) mixing together components (1A) and (1B); and
d) allowing the mixture to cure;
   or
   2)
a) mixing aggregate and amorphous silica and optionally additives and water to form a first component (2A);
b) providing the one or more bases, optionally mixed with water, as a second component (2B);
c) mixing together components (2A) and (2B); and
d) allowing the mixture to cure.

As it will be clear from the above, the method of the present invention is distinguished from that of the above-identified prior art. Thus, the method of the prior art first combines the reactive components, i.e. the components that form the binder (namely the amorphous silica, the one or more bases and water) in an initial step, whereupon the binder system, when the reaction therein has already started, is combined with the aggregate.

However, since the reaction In the binder system i.a. causes the binder to increase drastically in viscosity, establishing a homogeneous mixture between the aggregate and the binder is associated with some difficulties.

In contrast hereto, the method of the invention essentially establishes a method involving a two-component system so that the components of the binder, principally amorphous silica and the one or more bases, in the presence of water, are not brought into contact with one another until all the components of the entire materials system are present. This is a particular advantage of the method of the invention, because it enables the cured product to be manufactured in an continuous manner. This is so because one component of the binder may be evenly distributed or mixed with the aggregate before the second component of the binder is brought into contact with the first component. As the two components of the binders reacts the increase of the viscosity makes it difficult to further distribute or mix the binder with the aggregate. However, the need for mixing or similar means may be minimal or superfluous if the two components of the binder are distributed evenly onto the aggregate, preferably one or both component are in the state of a liquid or a vapour to facilitate the distribution.

Thus, in one variant of the first aspect, aggregate, the one or more bases and optionally additives and water are combined to form a first and preferably homogeneous component designated 1A, and amorphous silica, optionally mixed with water, is provided as a second component designated 1B, whereupon components 1A and 1B are combined (optionally involving an actual mixing process), and the mixture is allowed to cure. As it will be appreciated, the reaction involving the amorphous silica and the one or more bases in the presence of water cannot take place until step 1c) above where the entire system has been brought together in a homogeneous fashion.

Similarly, in a second variant of the first aspect, aggregate and amorphous silica and optionally additives and water are combined to form a first and preferably homogeneous component designated 2A, and the one or more bases, optionally mixed with water, are provided as a second component designated 2B, whereupon components 2A and 2B are combined, and the mixture is allowed to cure. As in the first aspect explained above, the reaction involving the amorphous silica and the one or more bases in the presence water cannot take place until step 2c) above where the entire system has been brought together in a homogeneous fashion.

In a second aspect, the invention relates to a cured product comprising amorphous silica, one or more alkali metal organosiliconate, and optionally additives, The alkali metal organosiliconate is preferably selected from sodium and potassium salts of an organosiliconate selected from methyl siliconate, ethyl siliconate, propyl siliconate, butyl siliconate and phenyl siliconate, preferable potassium methyl siliconate. The product of the second aspect differs from the product of the first aspect in that no aggregate is present. Examples of particularly relevant organosiliconates are Wacker BS-16 (54% aqueous solution of potassium methyl siliconate).

In a third aspect, the invention relates to a method for preparing a cured product comprising aggregate and a binder system, said binder system being derived from a mixture of an amorphous, Inorganic material M, one or more bases, and optionally additives, in a solvent, the method comprising

1)

a) mixing the aggregate, the one or more bases and optionally additives and solvent to form a first component (1A);
b) providing amorphous, inorganic material M, optionally mixed with water, as a second component (1B);
c) mixing together components (1A) and (1B); and
d) allowing the mixture to cure;
   or
   2)
a) mixing aggregate and amorphous, inorganic material M and optionally additives and solvent to form a first component (2A);
b) providing the one or more bases, optionally mixed with water, as a second component (2B);
c) mixing together components (2A) and (2B); and
d) allowing the mixture to cure.

The third aspect differs principally from the first aspect in that the amorphous silica is replaced by an amorphous, inorganic material M. The material M may have similar chemical and physical properties to the amorphous silica, in particular with regards to the ability to form a binder system as described above. The second aspect also differs in that the binder system may be derived from a solvent different from water, i.e. from a non-aqueous solution, such as an organic solvent, preferably a polar solvent like acetone or similar. Though, water may be applied and often preferred as a solvent.

The parts of the present application related to the first aspect are also understood to apply equally for the relevant parts related to third aspect. In particular, the different types, chemical and physical characteristics, amounts in recipes, examples etc. with respect to the aggregates and the bases may be applied for amorphous silica as well as for the amorphous, inorganic material M. Moreover, the remarks concerning the amorphous silica itself are understood to be valid also for the relevant possibilities of the inorganic, amorphous material M, i.e. the amorphous inorganic material M may comprise more than one structural variant, may comprise more than one relative distribution between the elements in M (e,g. FeO and Fe₂O₃), may comprise several portions with different surface areas, average particle sizes and so forth.

Preferably, the amorphous, inorganic material M may be an oxide, a hydroxide or an oxy hydroxide, a nitride or a carbide. Several different cations may then be comprised in M.

Preferably, the material M may comprise at least one element, preferably as a cation, from the group of: B, Al, Ga, In, Ti, Ge, Sn, Pb, Te, P, As, Sb, Bi, S, Se, and Te. In particular, amorphous compounds comprising Al, especially the oxides, hydroxides and the oxy hydroxides, may be relevant, as such species have many technical applications and are relatively high in abundance on earth. Other quite relevant amorphous species may be P₄O₁₀, A₂O₃, As₂Oₛ

Alternatively, the amorphous, inorganic material M may comprise at least one metal element, preferably as a cation, from the group of transition metals. In particular, compounds comprising cations of Fe, Mn, Ti, and Zn may be highly relevant. Amorphous compounds comprising Fe, especially the oxides, FeₓO_{y}, hydroxides, Feₓ(OH)_{y}, and the oxy hydroxides, FeₓO_{y}(OH)_{z}, may be very relevant, as such compounds have a broad range of applications and are relatively high in abundance on earth. Titanium oxide compounds may also be quite relevant.

More alternatively, the amorphous, inorganic material M may comprise at least one metal element from the group of lanthanoids or from the group of actinoids.

It is to be understood in this context, that the term “comprise” may have the meaning that the element forms a substantive part of the compound or species in question, and the meaning that the element forms only a fractional part, preferably even a very small part, more preferably even at an impurity level. The latter may be very relevant for doping purposes, e.g. doping with small amounts of metals or metal compounds that may have certain advantages with regard to catalytic properties, stabilising effects, retarding effects etc.

Preferably, the material M may be an amorphous mineral compound, preferably of natural origin. More preferably, the material M may be an amorphous clay-like compound, a micro-crystalline clay-like compound or similar.

### DETAILED DESCRIPTION OF THE INVENTION

All percentages are in percent by weight, unless otherwise stated.

In one variant, the one or more bases comprise an alkali metal organosiliconate as a mandatory constituent. A number of relevant and interesting embodiments of the present invention involve the use an alkali metal organosiliconate as well as a base as the one or more bases. The base may be brought into contact with the amorphous silica in a single step or in a number of steps. Thus, for some applications it may be interesting to start part of the binder reaction and at late stage complete the binder reaction.

In some situations, it can be an advantage to distribute or disperse a low-viscosity diluted base on the entire surface area of the aggregate in order to obtain a fast reaction between base and the amorphous silica as the silica is dispersed onto the aggregate. Possibly, the base could be dried after being applied on the aggregate.

Where the base component comprises an alkali metal organosiliconate as a mandatory constituent, the weight ratio between the amorphous silica and the organosiliconate(s) in the finished material prepared by the method of the invention is preferably in the range of 99:1 to 75:25. An embodiment of interest is a weight ratio between base and amorphous silica of 8-10% with no separate gel, thus no high viscosity colloid is obtained.

A number of different well-known materials can constitute the amorphous silica part of the binder system. Industrially produced amorphous silicas can be divided into at least four groups: silica gel, colloidal silica, precipitated silica and pyrogenic silica. Examples of such silicas are Aerosil®, Ketjensil®, Carbosil®, Cabosil®, Elkem Microsilica®, etc. Furthermore, other relevant amorphous silicas are of natural origin among which puzzolanes, Fuller's Earth, bentonite, fly-ash, tuff, pumice, etc.

Typically, relevant amorphous silica materials are materials not exclusively being constituted by SiO₂. Thus, it is generally believed that a certain amount of other inorganic impurities may be acceptable for the purposes described herein. However, the amorphous silica should comprise at least 60%, such as at least 70%, preferably at least 80%, in particular 90%, by weight of SiO₂. The amount of amorphous silica may be determined by an operational crystallographic method, such as by comparing the XRD spectrum with that of a Al₂O₃ corundum reference or similar. Commonly, amorphous silica samples contains small amounts of crystalline and/or micro-crystalline silica. As the amorphous silica over time decays into the (micro)-crystalline structure (ageing) this is an inherent property of amorphous silica. Presently, it is believed that crystalline silica does not participate in the binder reaction, but it is contemplated that at least part of the micro-crystalline silica may participate in the binder reaction.

The amount of silica (solids) In the binder system is preferably at least 50%, such as 60-99%, e.g. 65-95%, in particular 70-95%, by weight of the non-aqueous constituents.

It is presently believed that one of the important properties of the silica to be used within the present invention is the particle size which preferably should be in the range of 0.001-20 μm, such as 0.01-0.5 μm, in particular 0.05-0.1 μm. It is also presently believed that the specific surface area of the silica should be in the range of 1-1500 m² μg, such as 10-1000 m²/g, typically 10-500 m²/g, presently preferred 10-100 m²/g.

It is presently contemplated that ground (non-amorphous) silica materials, e.g. ground sand, may be used as long analogous with amorphous silica as long as the specific surface of such materials is above 10 m²/g.

The amorphous silica is preferably provided in the form of a slurry, in particular with due regard to the below-mentioned process for preparing the binder system. Slurries of silica to be used within the present invention should preferably comprise 20-80% by weight of silica.

The alkali metal organosiliconate is preferably selected from sodium and potassium salts of an organosiliconate selected from methyl siliconate, ethyl siliconate, propyl siliconate, butyl siliconate and phenyl siliconate, preferable potassium methyl siliconate.

When present, the amount of alkali metal organosiliconate (solids) is typically 1-25%, such as 2-20%, In particular 2-15%, by weight of the non-aqueous constituents of the binder portion of the material system prepared by the method of the invention.

The alkali metal organosiliconate is also often provided as an aqueous solution. The alkali metal organosiliconate content of such solutions is typically 1-80% such as 10-50%, preferably 20-45%, by weight. Examples of commercially available organosiliconates are Wacker BS-16 (54% aqueous solution of potassium methyl siliconate) and Wacker BS-20. It should be understood that even though reference is made to “a” silica and “an” alkali metal organosiliconate, each of those components as well as the base (see below) may actually be constituted by two or more different products or starting material so as to form a mixture of the constituent in question which fulfils the requirements (amount, qualities, etc.) defined herein. Thus, the silica constituent may be formed by two different silica qualities having different particle size distributions and/or the base constituent may be formed by, e.g. a liquid and a solid base component (e.g. hydroxides and cements).

In the events where a base (other than the alkali metal organosiliconate) is included either as a mandatory or as an optional constituent, such a base is preferably selected from alkali or alkaline earth metal hydroxides, such as sodium hydroxide, potassium hydroxide, magnesium hydroxide, and calcium hydroxide, alkali or alkaline earth metal silicates, aluminium silicates, iron(II) and iron(III) silicates and mixtures thereof, alkali or alkaline earth metal pyrosilicates, aluminium pyrosilicates, iron(II) and iron(III) pyrosilicates and mixtures thereof, alkali or alkaline earth metal carbonates, alkali or alkaline earth metal bicarbonates, alkali or alkaline earth metal phosphates, alkali or alkaline earth metal pyrophosphates, ammonia, and organic amines, such as primary, secondary, and tertiary amines, e.g., methylamine, dimethylamine, trimethylamine, ethylamine, diethylamine, triethylamine, and anilines, such as aniline, methylaniline and dimethylaniline, and cements (alkaline cements), such as basic Portland cement, rapid Portland cement, high early strength Portland cement, sulphate resistant cement, low-alkali cement, low heat cement, white Portland cement, Portland blast furnace cement, Portland pozzolana cement, Hasle cement, ultra Cement and aluminate cement (high alumina cement) and combinations thereof. In particular, the base or bases is/are selected from alkali metal hydroxides, alkaline earth metal hydroxides and cements, preferably selected from sodium hydroxide, potassium hydroxide and calcium hydroxide. A combination of two or more bases can also be used.

When present, the amount of base is typically up to 39%, such as 1-33%, in particular 2-28%, by weight of the non-aqueous constituents.

When the base is cement, Interesting foamy materials can be formed simply by mixing amorphous silica and cement slurries under vigorous mixing. The weight ratio between amorphous silica and cement is typically In the range of 80:20-50:50. Such products and their uses as insulating materials represent a further aspect of the present invention.

It is generally believed that the highest degree of hydrophobicity of the products of the present invention (see below) can be accomplished by using a larger amount of the alkali metal organosiliconate than the base, in particular when alkali metal organosiliconate is used alone. In the embodiments where a siliconate as well as a base is present, the weight ratio between alkali metal organosiliconate and base is preferably 10:1-1:10 such as 5:1-1:5.

The total amount of alkali metal organosiliconate and base will determine the degree of reaction of the amorphous silica. It is believed that advantageous properties—in particular with respect to the silica “egg” theory, vide infra—are obtained when the total amount of alkali metal organosiliconate and base it below the stoichiometric amount needed to react with all amorphous silica. It is believed that the stoichiometric ratio between amorphous silica and the total amount of alkali metal organosiliconate and base should be less than 1:1, such as in the range of 1:0.95-1:0.4, in particular 1:0.9-1:0.5.

It is presently believed that excess of the siliconate and the base (after reaction with the silica) should be avoided in order to avoid hygroscopic carbonates.

Furthermore, the mixture from which the binder system is derived may further comprise one or more additives (additional non-aqueous constituents). Such additives may be any other components used to modify the properties of the resulting binder system or of any products having the binder system included. An interesting group of additives are siliconates, especially due to the their hydrophobic properties. Examples of additives are surfactants, small amounts of organic solvents (even though generally undesirable for health and safety reasons), accelerators and retarders, etc. Examples of surfactants are non-ionic, anionic, and cationic surfactants. Examples of suitable surfactants are e.g. anionic surfactants such as derivatives of fatty acids wherein the negative charge is provided by a free carboxyl group, a sulphonate group, or a phosphate group, and such anionic surfactants commonly used in rinse aids; non-ionic surfactants such as esters or partial esters of fatty acids with an aliphatic polyhydric alcohol such as e.g. ethylene glycol, glycerol, sorbitol, etc., and the polyoxyethylene and polyoxypropylene derivatives of these esters, and such non-ionic surfactants commonly used in rinse aids; cationic surfactants such as derivatives of fatty acids, wherein the positive charge is provided by one or more quaternary ammonium groups, and such cationic surfactants commonly used in detergents. Fatty acids typically contain from 6 to 22 carbon atoms; examples are caproic, octanoic, lauric, palmitic, stearic, linoleic, linolenic, olesteric, and oleic acid, etc. Examples of applicable accelerators are e.g. calcium formate, calcium chloride, alkali metal nitrates, and ammonium nitrates. Examples of suitable retarders are polyhydroxycabocide, and alkali or alkaline earth metal phosphates. Small amounts of solid constituents (preferably less than 5%) may also be used as additives; examples of such solid “additives” are ultra-fine fibres, flakes, mica, etc.

The total amount of additives is typically 0-10%, such as 0-5%, preferably 0-3%, by weight of the non-aqueous constituents. When present, the amount is typically at least 0.01% by weight of the non-aqueous constituents.

Such additives may be vigorously mixed together with the alkali metal organosiliconate and base or may be added after the vigorous mixing as a final conditioning of the binder system. It is presently preferred that any additives are added together with the siliconate and base before mixing of those.

In one particularly interesting embodiment, the mixture from which the binder portion of the material prepared by the method of the invention is derived is an water-based mixture of amorphous silica, an alkali metal organosiliconate, optionally a base, and optionally additives, where the amorphous silica constitutes 60-99%, preferably 65-95%, in particular 70-95%, the organosiliconate constitutes 1-25%, preferably 2-20%, in particular 2-15%, the base constitutes 0-39%, preferably 1-33%, in particular 2-28%, and any additives constitutes a total of 0-10%, preferably 0-5%, in particular 0-3%, by weight of the non-aqueous constituents.

The present invention also provides a method for preparing a binder system as above, preferably a binder system derived from a mixture comprising amorphous silica, at least one of (a) an alkali metal organosiliconate and (b) a base, and optionally additives, the method comprising vigorously mixing an aqueous slurry of the amorphous silica with the at least one of (a) an alkali metal organosiliconate and (b) a base, and the optional additives, said mixture having an initial pH in the range of 11.5-14 and a final pH in the range of 7.5-11.0.

An important observation is that the upon storage over several months, yet another pH drop of the product is seen in extraction experiments. Simultaneously, an enhancement of the mechanical properties is observed. Thus, some kind of post-curing or post-hardening effect is observed. It is presently contemplated that this is due to excess amount of base present in product, the base reacting with the atmospheric carbonic acid (H₂CO₃/CO₂). At least such an reaction will occur for some organosiliconates, such as potassium methyl siliconate. Thus, manipulation of the storage atmosphere over time enables certain changes of the product properties to be implemented.

It is preferred that the vigorous mixing of silica, the at least one of (a) an alkali metal organosiliconate and (b) a base and the optional additives is performed using a high-speed mixer so as to obtain a substantially uniform mixture of reacted silica particles, said silica particles being at least partially, but not fully, reacted with the at least one of (a) an alkali metal organosiliconate and (b) a base.

It should be understood that the remainder of the binder portion of the material system prepared by the method of the invention is water. The above-mentioned amounts of non-aqueous constituents may be obtained directly by using the indicated amounts before mixing. Alternatively, the binder system may be diluted by addition of further water. Also, excess water may be removed after preparation, but before use of the binder system. The amount of non-aqueous constituents may be in the range of 5-40% by weight, such as 7-30% by weight, of the water-based binder system, or even higher, e.g. up to 95% solids. The amount of water present in the binder system is critical for the binding properties. Thus, too much water present results too low pH values and in a low cohesion of the binder. Too little water may result in an inhomogeneous distribution of one or more components and no or limited reaction. Deficit of water may at least partly be compensated by intensive mixing of product during curing. The amount of water present in the binder is to some degree controllable by the hydrophobic properties of the aggregate, i.e. the more water-repellent the aggregate is, the less water is needed. For example may the good weeting properties of Wacker BS-16 (54% aqueous solution of potassium methyl siliconate) be exploited. Methods from gluing technology, such as matching of interfacial tension and zeta potential, may be applied to achieve the maximum contact area both between the binder and the aggregate, and between the two binder components. Advantageously, the aggregate and part of binder may chemical bond and/or be physical integrated, e.g. by cavities in the aggregate.

Without being bound to any specific theory, it is believed that the present invention is particularly interesting and relevant where the preparation of the binder system is conducted in such as way that the amorphous silica is only partially reacted and dissolved, i.e. so that the at least a part of the fine particles is unreacted after treatment with the alkali metal organosiliconate and/or base, although some of the smallest particles may be fully reacted. When view in another way, it is believed that the silica particles are partially reacted with the siliconate and/or base so as to have a sticky surface similar to frog's eggs. When applied to a batch of mineral fibres and/or mineral particles, it is believed that the silica “eggs” after curing will provide further stability to the fibre web or bundle, which will result in improved form-stability. The preliminary theory is supported by the fact that the results obtained when using a binder system prepared from silica and potassium hydroxide (stoichiometric ratio 1:<1) provides better results than a comparative binder system constituted by potassium water glass. This being said, a variant where the silica is fully dissolved is also contemplated within the present invention.

As indicated above, the aggregate used in the method of the invention may be inorganic and/or mineral materials in the form of fibres or particles such as volcanic rock fibres, wollastonite fibres, montmorillonite fibres, tobermorite fibres, biotite fibres, atapulgite fibres, calcined bauxite fibres, etc., mineral wool, whiskers, sand, expanded clay, wollastonite, perlite, expanded perlite, vermiculite, expanded vermiculite, exfoliated vermiculite, ceramic fibres, Leca®, any man-made vitreous fibre, glass fibres including micro glass fibres, Rockwool® fibres, processed mineral fibres from mineral wool, and also inorganic fillers such as crushed minerals or other fine-grained minerals; and organic materials such as cellulose fibres and EPS spheres.

In another embodiment, the aggregate is steel bars or reinforcement bars/mesh used in construction of buildings, bridges, towers, etc. As the binder has a lower effective pH value than concrete, steels bars within the binder of the present invention are also less susceptible to corrosive attacks. Application of the binder to encapsulate steel bars or reinforcement bars/mesh before insertion into concrete construction parts is also a possibility. Use of the present invention on construction sites is particularly advantageous as the two components of the binder can be brought into contact on the site of application. Thus, pre-defined amounts of the two binder components can be stored in separate containers, bags or similar and applied directly onto the aggregate. Mixing of the two binder components can be performed at the place where the aggregate parts are installed, or next to the aggregate parts, possibly just on the site of construction depending on the drying and curing time of the specific binder system. Pre-defined amounts of the two binder components stored in separate containers including aggregate material is also possible. The aggregate could be for example be flakes or scales of vermiculite. Mixing flakes of vermuculite (expanded) with Wacker BS-16 (54% aqueous solution of potassium methyl siliconate) or diluted solutions thereof (e.g. 5-20% of vermuculite) yields a shapeable reinforcement product.

It should be understood that the aggregate present in the product prepared by the method of the invention may comprise both mineral fibres, and mineral particles. In a particularly interesting embodiment the invention relates to a cured product comprising amorphous silica, one or more bases, optionally additives, and a mineral, such as vermaculite, glas, or mica as aggregate, the aggregate having the form of sub-micron thin flakes or scales. In the present context of the invention, the term “particles” is meant to include such thin flakes or scales. The vermaculite may be delaminated into flakes or scale by application of well known methods. The flakes or scales may have a thickness in the range from typically 0.1-100 nm, such as 0.5-20 nm, preferably 1-10 nm. Some flakes may be up to several microns thick. Length and width of the flakes or scales may be 0.1-5 cm. Other relevant flake material are various mica types: muscovite, bronze or black mica, Preliminary results have indicated that a cured product with such flakes or scales bound by the binder of the present invention has extraordinary good mechanical characteristics. The reinforcement product can be applied alone or as a shielding for other constructive elements, such as plaster or cement parts,

Products based on expanded perlite or exfoliated vermiculite constitute an interesting embodiment due to their potential excellent insulating properties, i.e. heat, sound, and fire insulating properties. It is believed that compositions where the weight ratio between the binder portion (solids) and perlite is in the range of 4:1-1:10 such as 4:1-1:5 are particularly interesting. The binder system is as defined and specified above.

The drying and curing step should always (as will be apparent to the person skilled in the art) be conducted with due regard to the nature of the constituents of the binder system and the mineral fibres/particle, however in the following will be given general guidelines for the drying and curing step. It should be noted that drying and curing is generally considered as one step as the drying (removal of water) will take place simultaneously with the curing, however as the curing typically will proceed more slowly in highly diluted systems, drying will be predominant in the initial phase of the drying and curing step and the curing will be predominant in the later phase of this step. It should be noted that the drying and curing step could be undertaken both passively, i.e. merely by letting the product rest without heating, or actively with assisting heating. Possibly, the surrounding atmosphere of the product may be controlled in order to manipulate the drying and curing step.

The drying and curing is typically initiated in a pre-curing phase by raising the temperature, e.g. by moderate heating to a temperature in the range of 30-60° C., such as, but not generally required, in an inert or low-reactive atmosphere, e.g. a humidified atmosphere, in order to allow the base to begin dissolving the silica component. Subsequent heating to 60-200° C., such as 65-150° C., preferably 70-100° C., will lead to curing of the binder. It is recommended that the water content should be less than about 50% by weight of the binder system before the temperature is Increased to above around 100° C. (local boiling temperature for water), this particularly applies where thick layers of binder is applied in order to avoid the formation of imperfection in the product due to chock boiling of the water. It is also recommended to keep a homogenous temperature throughout the product during drying and curing to avoid thermal tensions.

In the present context the term “ultra-fine silica” is intended to designate SiO₂-rich particles having a specific surface of about 50 m²/g to 200 m²/g, especially about 10 m²/g to 50 m²/g. Such a product is produced as a by-product in the production of silicon or ferrosilicon metal in electrical furnaces and comprises particles in a particle-size range from about 50 Å to about 0.75 μm, typically in the range from about 200 Å to about 0.75 μm.

In the present context the term “fibres” is intended to mean any fibres within the groups of natural inorganic fibres, synthetic inorganic fibres, natural organic fibres, synthetic organic fibres, and metallic fibres, or mixtures thereof, preferably inorganic or organic fibres or mixtures thereof. Furthermore, the term “fibres” is intended to cover monofilaments, split fibres, and stable fibres of any cross section. Thus, the term also comprises bands, granules, needles, whiskers, and strips. The fibres may or may not have been surface treated or coated.

Thus, in an interesting embodiment of the method according to the invention, the material prepared by the method of the invention also comprises one or more filler bodies such as fibres and particles. Preferred examples of fibres are silicon-containing fibres, metal fibres, oxide fibres, carbon fibres, glass fibres including micro glass fibres, Rockwool fibres, processed mineral fibres from mineral wool, volcanic rock fibres, wollastonite fibres, montmorillonite fibres, tobermorite fibres, biotite fibres, atapulgite fibres, calcined bauxite fibres, aromatic polyamide fibres, aromatic polyester fibres, aromatic polyimide fibres, cellulose fibres, cotton fibres, flax fibres, rubber fibres and fibres of derivatives of rubber, polyolefin fibres including polyethylene and polypropylene fibres, polyacetylene fibres, polyester fibres, acrylic fibres and modified acrylic fibres, acrylonitrile fibres, elastomeric fibres, protein fibres, alginate fibres, poly(ethylene terephthalate) fibres, polyvinyl alcohol fibres, aliphatic polyamide fibres, polyvinylchloride fibres, polyurethane fibres, vinyl polymeric fibres, and viscose fibres, modified by any chemical or physical processes, and any mixtures thereof.

Preferred fibres are micro glass fibres, mineral wool, Rockwool® fibres, wood fibres, plant fibres, polypropylene fibres and polyethylene fibres. Thus, the binder of the present invention may replace phenol-based binders conventionally used in heat-insulating products such as mineral wool and Rockwool®. These phenol-based binders often represents a health hazard. Additionally, the hydrofobic properties of the binder according to the invention can be relatively easy modified by appropriate additives or by using a larger amount of alkali metal organosiliconate than base as explained above.

In a particular interesting embodiment of the invention the material prepared by the method of the invention comprises one or more filler bodies selected from cellulose fibres. Specific examples of cellulose fibres are for example cotton fibres, wheat fibres, agar fibres, flax fibres, pea fibres, barley fibres, oat fibres, cocoa fibres, coffee fibres, orange fibres, citrus fibres, apple fibres, tomato fibres, carrot fibres, soya fibres and acacia fibres. The presently most preferred cellulose fibres are fibres selected from example cotton fibres, wheat fibres and agar fibres.

In another interesting embodiment of the invention the cellulose fibres may be obtained from a paper source such as chopped newspapers, chopped virgin paper or paper which has been de-fibrated by means of a hammer mill. Experiments have shown that by reacting the cellulose fibres initially with the base a highly cohesive light material with excellent mechanical properties is obtained. It is contemplated that the base reacts with the amorphous part of the cellulose fibres resulting in an open structure of the cellulose fibres, wherein the binder may enter afterwards. It should be noted that the cellulose fibres does not react with the binder system, thus the cellulose fibres are preserved within the binder system.

As will be apparent from the examples provided herein chopped paper may be prepared by cross-cutting the paper in a shredding machine. Preferably the cross-cut paper has a length of 0.1 to 1 mm and a width of 0.4 to 0.9 mm.

It should be understood that the amount of cellulose fibres present in the porous material constitutes a compromise; the amount of cellulose fibres should one the one hand be as large as possible in order to increase the absorption properties of the porous material but, on the other hand, the amount of cellulose fibres should be as low as possible in order to prevent or reduce the inflammability of the porous material. It has been found by the present inventors that in order to obtain satisfactory absorption properties, the amount of cellulose fibres in the porous material will generally be in the interval from 4% to 75% by weight, preferably 10% to about 50% by weight, in particular from 15% to about 35% by weight.

Examples of suitable particles are particles which tend to be insoluble under the conditions prevailing during the reaction between the ultra-fine silica and the porosity-conferring component, e.g., fine (but not ultra-fine and not reactive) silica particles such as ground quarts and silica gel particles, other ground mineral particles such as heavy spar, bentonite, coke, diatomite, dolomite, feldspar, kaolin, pumice, spherical and hollow particles, carbon particles, talc, mica, perlite, expanded perlite, vermiculite, expanded vermiculite, exfoliated vermiculite, kiselguhr, aluminium silicate, chalk, and fly ash etc. Especially interesting filler particles are porosity-enhancing bodies such as mica, chalk, perlite, vermiculite, such as exfoliated vermiculite and expanded perlite, or combinations thereof.

In another embodiment of the method of the invention, the material may comprise one or more organic components such as straw, cellulose fibres, polymer fibres, textile fibres, cotton fibres, flax fibres, pulverised plant shells etc., so that when the porous bodies made from the material are incinerated, typically at a temperature around 700° C. in an inert atmosphere, the organic components will carbonise, i.e. the final porous bodies will be carrying elemental carbon on surfaces thereof, so as to establish an economical “supported” active carbon.

Furthermore, in some cases it may be advantageous to add surfactants to the reaction mixture. Thus, addition of non-ionic, anionic, and cationic surfactants to the reaction mixture may provide a more smooth processing (e.g. extrusion) of the material. However, the addition of surfactants to the reaction mixture is not presently preferred.

The materials should preferably have a bulk density in the range from typically about 100 kg/m³ to about 2000 kg/m³ such as about 200 kg/m³ to about 1000 kg/m³, preferably about 300 kg/m³ to about 700 kg/m³. However, for certain insulating materials the density can be as low as 8 kg/m³. It is a particular advantage of the invention that low density, open structured or porous products are obtainable, possibly with no or little mixing of the aggregate and the binder components before curing and drying. Thus, with for example cellulose fibres as aggregate, mixing of the fibres would be complicated and possibly necessitate some kind of fixation of the cellulose fibres. This is not needed with the method of the present invention.

Products obtained by the present invention have excellent mechanical and thermal properties relative to their density. In particular, results obtained by the European pre-standard prENV 993-11 shows that the products have good resistance to thermal chock. It is contemplated that this is due to a high degree of internal polymerisation of the binder. Furthermore, the products are typically heat resistant and non flammable as evidenced by flame tests. Preliminary results also indicates a good acid resistance, especially relative to concrete.

When applying a strong base (such as e.g. lime water) the initial pH In the aqueous phase is usually at least 10, such as at least 10.5, preferably at least 11. In this specific case the reaction is preferably continued until the pH In the aqueous phase is at the most 9, or at the most a pH which will secure a specific surface area of at least 25 m²/g, e.g. at least 50 m²/g, such as at least 100 m²/g, preferably at least 200 m²/g, even more preferably at least 300 m²/g, in particular at least 400 m²/g, especially at least 500 m²/g, such as at least 600 m²/g.

Without being bound by a specific theory, it is believed that the above-mentioned pH-drop is provided by the excess of silica present in the reaction mixture. It is believed that the decrease in the pH is of outmost importance, and therefore, in another embodiment, wherein silica is not present in excess, the pH-drop may be provided by addition of acidic components to the reaction mixture, such as silica, mica, inorganic acids, such as hydrochloric acid, hydrobromic acid, sulphuric acid, nitric acid, etc. and organic acids, such as acetic acid, propionic acid, etc. and such acids as known to a person skilled in the art.

It will be understood from the examples provided herein that the material, while still shapeable, that is, before hardening, is easily converted into almost any shape desirable. Thus, the material is easily converted into a body or bodies of sheets, plates, firm and brittle pellets, bars, sticks, bricks, pipes, tubes, tapes, noodles, shells, fibre-like products, and spaghetti-like products etc., by means of methods known to a person skilled in the art, such as extrusion, casting, pressing, moulding, injection moulding, etc., optionally combined with or followed by evaporation and/or heating. An often preferred method is to extrude the material, while extrudable, into a multitude of strings of a cross-sectional dimension, such as diameter, of, e.g. 1-5 mm and chop the strings in short lengths, typically 3-30 mm such as 5-12 mm, to form pellets which are then hardened, typically by drying.

In another embodiment the material is then stored in an atmosphere of at least 75% relative humidity, such as at least 80% relative humidity, preferably at least 85% relative humidity, even more preferably at least 90% relative humidity, such as at least 99% relative humidity, in order to pre-harden the material. Optionally, the material is then subjected to a final drying step in order to remove excess water.

In general, materials which exhibit a neutral pH when suspended in water are preferred. Thus, in a preferred embodiment the material (with or without storage under humid conditions) has a pH in the range of 5 to 9, such as in the range from 5.5 to 8.5, preferably in the range from 6 to 8, even more preferably in the range from 6.5 to 7.5, e.g. around 7, based on a 4 mg ground sample of the material suspended in 25 ml demineralised water.

Thus, by employing the modified process the extrusion step may be avoided. In general, the slightly modified method comprises the following steps: The fibres are added to a silica slurry (preferably comprising from about 30% to 70% by weight of silica, preferably around 50% by weight) while stirring and, in the case of cellulose fibres, while blending the mixture in order to de-fibrate (or partly de-fibrate) the cellulose fibres until a thixotropic mass (viscous paste) is obtained. Stirring is then continued until a “dough-like” material is formed. If only a small amount of fibres (i.e. less than about 10-20% by weight) is employed it will normally be necessary to add perlite (typically from 10% to 70% by weight) in order to obtain the above-mentioned “dough-like” structure of the material.

The method of the invention is further illustrated by the following, non-limiting example.

### EXAMPLE

A material is prepared from amorphous microsilica, exfoliated vermiculite as the aggregate and KOH as the base. The preparation is carried out according to several different procedures.

Procedure 1: Exfoliated vermiculite is mixed with microsilica (component 1). To the mixture of vermiculite and microsilica a solution of KOH (component 2) is added. This procedure corresponds to method 2) as defined above.

Procedure 2: Exfoliated vermiculite is mixed with a solution of KOH (component 1). To the mixture of vermiculite and KOH-solution is added microsilica (component 2). This procedure corresponds to method 1) as defined above.

Finally, for comparison purposes, a procedure (designated procedure 0) corresponding essentially to the prior art of WO 0026154 is applied by first preparing the binder and then combining the binder with the aggregate. Thus, the mixing sequence is that microsilica slurry (grade 500S from Elkum Materials) is mixed with water, then addition of KOH flakes, and finally vermiculite.

The exfoliated vermiculite had particle sizes between 0.125 mm and 2 mm (Skamol grade “superfine”, available from Skamol, Denmark)). The microsilica was a dry powder from Elkem Materials, Norway, grade 940U. The potassium hydroxide solution used was made by mixing technical grade potassium hydroxide flakes with tap water.

Procedure 1

Several materials were prepared using procedure 1 in accordance with the mix proportions seen in the Table 1 below.

TABLE 1

| Material | A-2 (mass, g) | A-4 (mass, g) | A-6 (mass, g) |
|---|---|---|---|
| Vermiculite | 639.47 | 578.57 | 506.25 |
| Microsilica | 156.88 | 212.91 | 279.45 |
| KOH | 13.64 | 18.51 | 24.3 |
| Water | 255.79 | 347.14 | 455.63 |

The mixing of vermiculite and microsilica was performed by placing both in a plastic drum and shaking the drum vigorously. The mixture of vermiculite and microsilica was subsequently placed in a kitchen mixer, and the KOH solution was sprayed on over a 2-4 minute period with the mixer rotating at very low speed (30 rpm).

The final mixture was transferred as quantitatively as possible to a mould placed in small hydraulic press, and pressed to a slab of dimensions 300 mm×300 mm×15 mm. The fresh slab was wrapped in plastic and placed in an oven at 60° C. for 1 hour. After the 1 hour “pre-curing”, the plastic was removed and the slab was placed In an oven at 90° C. for 20 hours. The density of the slabs are given in Table 2.

TABLE 2

| Slab identification | Density, dry, kg/m³ |
|---|---|
| A-2 | 568 |
| A-4 | 568 |
| A-6 | 569 |

Procedure 0

Comparison slabs—designated D-2, D-4 and D-6, were prepared in the same manner as under Procedure 1, but where the starting materials (same proportions as in Table 1 above) were combined by first mixing the microsilica slurry and water, adding KOH, and finally adding the vermiculite (i.e. according to Procedure 0).

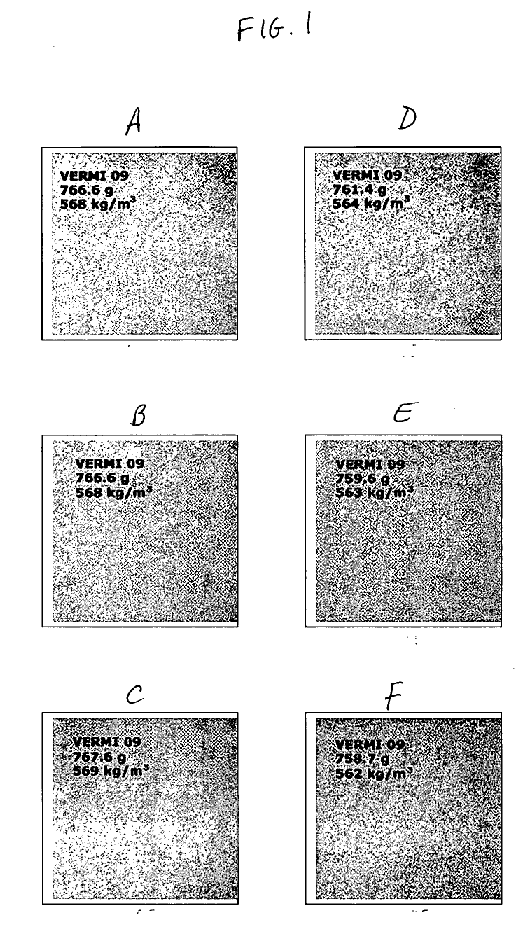

Upon visual evaluation it was observed that the slabs manufactured using Procedure 1 are more homogeneous than those manufactured by Procedure 0, i.e. a better distribution of binder is achieved. The greater homogeneity of “Procedure 1 slabs” is illustrated in FIG. 1. When evaluating the images it is important to notice that the slabs A have a more uniform colour, i.e. the surfaces are less spotty. (The general difference in darkness between slabs A and D is not important, as it is a result of slabs D being made with a slightly darker silica than slabs A.)

TABLE 3
Density of slabs manufacture by Procedure 0.

| Slab identification | Density, dry, kg/m³ |
|---|---|
| D-2 | 564 |
| D-4 | 563 |
| D-6 | 562 |

1. A method for preparing a cured product comprising an aggregate and a binder system, said binder system being derived from an aqueous mixture of amorphous silica, one or more bases, and optionally additives, the method comprising:
(1)
a) mixing the aggregate, the one or more bases and optionally additives and water to form a first component;
b) providing amorphous silica, optionally mixed with water, as a second component;
c) mixing together the first and second components; and
d) allowing the mixture to cure;
or
(2)
a) mixing aggregate and amorphous silica and optionally additives and water to form a first component;
b) providing the one or more bases, optionally mixed with water, as a second component;
c) mixing together the first and second components in (2); and
d) allowing the mixture to cure.

2. A method according to claim 1 wherein the base is selected from an alkali metal organosiliconate, alkali or alkaline earth metal hydroxides, alkali or alkaline earth metal silicates, aluminium silicates, iron(II) and iron(III) silicates and mixtures thereof, alkali or alkaline earth metal pyrosilicates, aluminium pyrosilicates, iron(II) and iron(III) pyrosilicates and mixtures thereof, alkali or alkaline earth metal carbonates, alkali or alkaline earth metal bicarbonates, alkali or alkaline earth metal phosphates, alkali or alkaline earth metal pyrophosphates, ammonia, organic amines, and cements, and combinations thereof.

3. A method according to claim 2 wherein the alkali metal organosiliconate is selected from sodium and potassium salts of a lower alkyl organosiliconate or an aryl siliconate.

4. A mineral product according to claim 2, wherein the alkali metal organosiliconate is potassium methyl siliconate.

5. A method according to claim 2, wherein the base is selected from the group consisting of alkali metal hydroxides, alkaline earth metal hydroxides and cements.

6. A method according claim 1, wherein the aggregate is selected from the group consisting of organic or inorganic fibres, organic particles and inorganic particles.

7. A method according to claim 6 wherein the organic or inorganic fibres are selected from the group consisting of silicon-containing fibres, metal fibres, oxide fibres, carbon fibres, glass fibres, Rockwool fibres, processed mineral fibres from mineral wool, volcanic rock fibres, wollastonite fibres, montmorillonite fibres, tobermorite fibres, biotite fibres, atapulgite fibres, calcined bauxite fibres, aromatic polyamide fibres, aromatic polyester fibres, aromatic polyimide fibres, cellulose fibres, cotton fibres, flax fibres, rubber fibres, fibres of derivatives of rubber, polyolefin fibres, polyacetylene fibres, polyester fibres, acrylic fibres, modified acrylic fibres, acrylonitrile fibres, elastomeric fibres, protein fibres, alginate fibres, poly(ethylene terephthalate) fibres, polyvinyl alcohol fibres, aliphatic polyamide fibres, poly-vinylchloride fibres, polyurethane fibres, vinyl polymeric fibres, viscose fibres, and any mixtures thereof.

8. A method according to claim 6 wherein the organic or inorganic particles are selected from the group consisting of silica particles, ground mineral particles, carbon particles, talc, mica, vermiculite, perlite, pumice, kiselguhr, aluminium silicate, chalk, fly ash, pulverized plant shells, porosity-enhancing bodies and combinations thereof.

9. A method according claim 1 wherein the additives are selected from the group consisting of surfactants, organic solvents, accelerators and retardants.

10. A method according to claim 9 wherein the surfactant is selected from the group consisting of non-ionic, anionic, and cationic surfactants.

11. A material prepared by a method according to claim 1.

12. A material comprising amorphous silica, one or more bases, optionally additives, and aggregate in the form of sub-micron thin flakes or scales of a mineral.

13. A cured product comprising amorphous silica, one or more alkali metal organosiliconates, and optionally additives.

14-37. (canceled)

38. The method according to claim 3, wherein the lower alkyl organosiliconate is selected from the group consisting of methyl siliconate, ethyl siliconate, propyl siliconate and butyl siliconate.

39. The method according to claim 3, wherein the aryl siliconate is phenyl siliconate.

40. The method according to claim 5, wherein the metal hydroxide is selected from the group consisting of sodium hydroxide, potassium hydroxide and calcium hydroxide.

41. The method according to claim 7, wherein said polyolefin fibers are polyethylene fibers or polypropylene fibers.

42. The method according to claim 8, wherein said ground mineral particles are selected from the group consisting of heavy spar, bentonite, diatomite, dolomite, feldspar, kaolin, spherical and hollow particles.

43. The method according to claim 8, wherein said porosity-enhancing bodies are selected from the group consisting of mica, chalk, expanded perlite and exfoliated vermiculite.

44. The method according to claim 10, wherein said anionic surfactant is a derivative of a fatty acid, wherein the negative charge is provided by a free carboxyl, sulfonate or phosphate group.

45. The method according to claim 10, wherein said non-ionic surfactant is an ester or partial ester of a fatty acid having an aliphatic polyhydric alcohol moiety, a polyoxyethylene derivative thereof or a polyoxypropylene derivative thereof.

46. The method according to claim 10, wherein said cationic surfactant is a derivative of a fatty acid, wherein the positive charge is provided by one or more quaternary ammonium groups.

47. The material of claim 12, wherein said aggregate is selected from the group consisting of vermiculite, glass and mica.
